(19) United States
(12) Patent Application Publication
(10) Pub. No.: US 2012/0265842 A1
(43) Pub. Date: Oct. 18, 2012

(54) CREATING OPERATING SYSTEM INTERNET CONNECTIONS FOR MOBILE APPLICATIONS

(76) Inventor: MARTIN MOSER, Speyer (DE)

(21) Appl. No.: 13/085,938

(22) Filed: Apr. 13, 2011

(51) Int. Cl. G06F 15/16

(52) U.S. Cl. 709/217

(57) ABSTRACT

Various embodiments of systems and methods for creating operating system internet connection for mobile applications are described. According to one aspect, the methods include requesting an Internet connection to be created in a service thread separate from the operating system thread of a mobile device. In a further aspect, the Internet connection is created in parallel to loading the mobile application data into the faster memory of the mobile device and starting the mobile application in a separate application thread. Hence, when the mobile application is started and the application data is initialized, the Internet connection is created and ready for use by the mobile application.

### FIELD

The field generally relates to the software arts, and, more specifically, to methods and systems for creating operating system internet connections for mobile applications.

### BACKGROUND

Mobile applications represent software applications developed for handheld devices such as personal digital assistants, enterprise digital assistants, and mobile phones. These applications are either pre-installed on phones during manufacture or downloaded by customers from different vendors. Mobile software is developed by using different platforms and programming languages based on the target mobile device.

Mobile Applications for handhelds and laptops allow customers to mobilize their business processes for handheld devices, such as Personal Digital Assistants (PDAs), and laptops. Target users for mobile applications are those who need to access information while they are away from the office. Users can include sales executives, field service engineers, or delivery personnel, for example. These users occasionally connect to a Data Orchestration Engine (DOE) to synchronize applications and to exchange data. The DOE supports the data exchange between the handheld and the backend system.

Most mobile applications are online applications, that is, they send and request information over an Internet connection from the mobile device to the backend system. Due to the nature of the available technology (mobile carrier waves), establishing an Internet connection from the mobile device could be quite slow. For example, establishing an Internet connection over a mobile carrier such as T-Mobile® or Verizon® could take between two and four seconds. Hence, the response time for the first request made to the backend system is generally significantly higher than the time to send the information to the backend system and process it there. Typically, the transmission of data is in the range of one second per 20 KB of information, while server response times are in the range of half a second. Some protocols, such as LTE50, allow for up to ˜2.8 MB/sec.

### SUMMARY

Various embodiments of systems and methods for creating operating system Internet connections for mobile applications are described herein. In various embodiments, the method includes requesting an Internet connection from an operating system of a mobile device for a mobile application. In one aspect, the Internet connection is created in a service thread, wherein the service thread is separate from an operating system thread that executes tasks of the operating system. In a further aspect, the method further includes loading mobile application data into internal memory of the mobile device in parallel to creating the Internet connection. The mobile application is started in an application thread in parallel to creating the Internet connection. Finally, in another aspect, a notification is received that the Internet connection is created shortly after or during the loading of the mobile application data and starting of the mobile application.

In various embodiments, the system includes a processor and a memory in communication with the processor. According to one aspect, the memory includes an operating system thread that requests an Internet connection for a mobile application, loads the mobile application in internal memory of a mobile device, and starts the mobile application in a separate thread. In a further aspect, the memory includes a service thread that creates the Internet connection in parallel to loading the mobile application and starting the mobile application by the operating system thread and sends a notification that the Internet connection is created shortly after or during the loading of the mobile application data and starting of the mobile application. Finally, the memory includes an application thread that receives the notification that the Internet connection is created and available.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a current technology for creating an Internet connection for a mobile application.

FIG. 2 is a block diagram illustrating a method for creating an Internet connection for a mobile application, according to an embodiment.

FIG. 3 is a flow diagram illustrating the method for creating an Internet connection in an operating system of a mobile device, according to an embodiment.

FIG. 4 is block diagram illustrating a method for creating a network connection between a mobile device and a backend system, according to an embodiment.

FIG. 5 is a block diagram illustrating an exemplary computer system 500.

### DETAILED DESCRIPTION

Embodiments of techniques for creating operating system Internet connections for mobile applications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

There are mobile applications that take up to several seconds to start, that is, several seconds pass before user input is accepted without the mobile application doing any network communication. In various embodiments, an operating system Internet connection is created for mobile applications on a mobile device that significantly shortens the time period from starting a mobile application until the point the mobile application receives a response to the first request sent to the backend system.

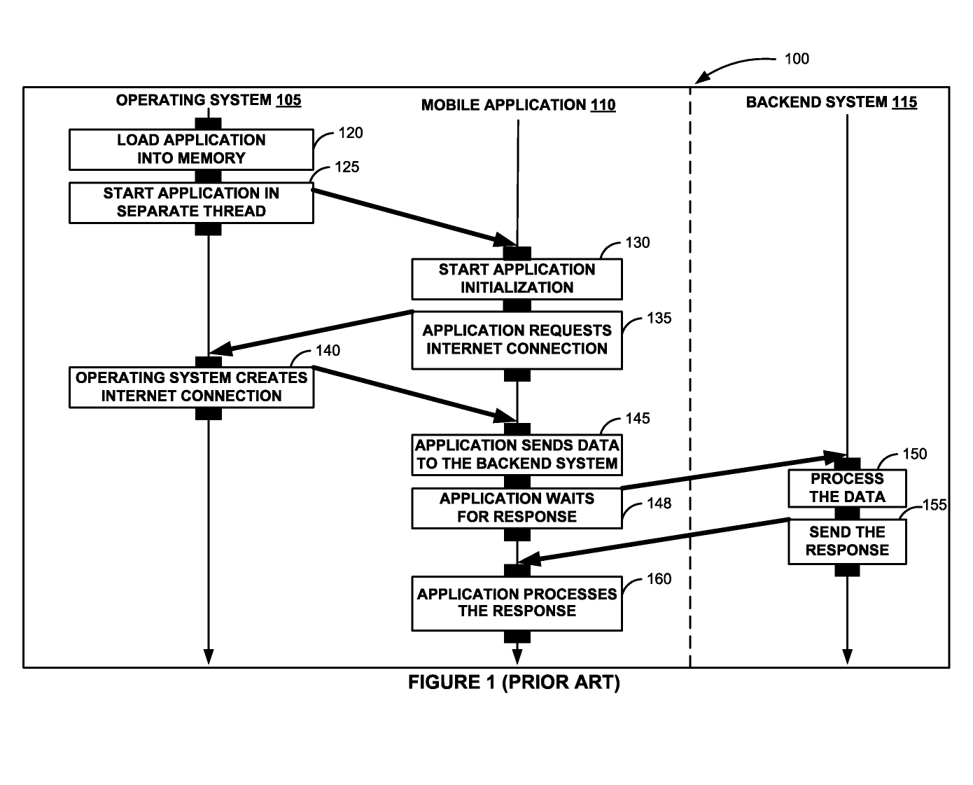

FIG. 1 is a block diagram illustrating a current technology for creating an Internet connection for a mobile application. Process 100 illustrates the steps performed by the operating system 105 of a mobile device, the mobile application 110 hosted on the mobile device, and the backend system 115 to establish an Internet connection from the mobile device to the backend system 115. Thus, process 100 includes steps performed on the mobile device and steps performed on the backend system. Operating system 105 is the operating system installed on the mobile device. Mobile application 110 can be any online mobile application that sends and receives data over an Internet connection. Backend system 115 can be an enterprise system, an application server, or any other system that contains the data relevant for the business needs of the mobile application 110. At block 120, the operating system 105 of the mobile device loads the mobile application 110 into the main memory of the mobile device. The slowest and one of the possible scenarios include a faster memory (internal memory) and a slower memory (a mass storage device, e.g., a hard disk, a memory card, etc.) as part of the mobile device. Typically, the mobile application 110 resides in the slower memory and to be executed, the mobile application 110 has to be copied to the faster memory. Hence, the operating system 105 loads the mobile application 110 into the faster internal memory for execution.

At block 125, the mobile application 110 is started (e.g., creating descriptive and lookup tables) by the operating system 105, so that the execution of the mobile application 110 can begin. Typically, this takes some time. The control is handed over from the operating system 105 to the mobile application 110. At block 130, the mobile application 110 starts initialization of the internal memory for the application data. For example, the mobile application needs to build up user interfaces, perform initializations of some variables, load initialization files or data, perform some computations, and so on. Generally, in a simple scenario, the first thing that a mobile application needs to do is to read data from the Internet. For example, when searching a term from a mobile device, the user interface (UI) of a search engine is displayed on the mobile device screen, the user enters the search term, and selects the search button. It should be noted that the “search” scenario is just an example of a mobile application reading data from the Internet and any other scenario involving creating an Internet connection can be used. At block 135, the mobile application 110 sends a request to the operating system 105 to create an Internet connection for the user request. As soon as the mobile application 110 requests an Internet connection, the mobile application needs to access the operating system. The mobile application 110 may use an operating system API or library to request the Internet connection from the operating system 105. The control is handed over back to the operating system 105.

At block 140, the operating system 105 creates an Internet connection for the user request for the mobile application 110. At that moment, the Internet connection is being created between the mobile device and the backend system hosting the search engine data and functionality. First, the operating system 105 builds up a mobile connection to the next relay tower in the facility where the mobile devise is located and then a connection over the network (Internet) to the backend is established. Thus, on top of the mobile connection, there is a TCP/IP connection as well. Typically, this takes quite some time, because the mobile connection needs to wait for a free slot at the relay tower so that the Internet connection can be established. Generally, the relay towers are organized in a way that a certain number of connections can be open. Therefore, it may take quite some time (e.g., several seconds) until a free slot is available at the relay tower.

When eventually the Internet connection is established, the control is handed over again to the mobile application 110. At block 145, the mobile application starts sending data over the network (e.g., the Internet) to the backend system. Then the mobile application 110 needs to wait for a response from the backend system, at block 148. If there is a synchronized communication between the mobile device and the backend system, the mobile application 110 will wait for the backend server to respond. At block 150, the backend system processes the data received with the user request from the mobile application 110. At block 155, the backend system sends the response to the mobile application 110. At block 160, the mobile application 110 processes the response, e.g., displays a result on the mobile device screen.

The different steps are performed in different threads. For example, the steps performed by the operating system 105 are performed in an operating system thread, the steps performed by the mobile application 110 are performed in an application thread, and the steps performed by the backend system are performed in a server thread. The bold arrows between the blocks in process 100 show which thread will become active. Further, the connections between the blocks in the different threads end with thicker edges showing consumption of Central Processing Unit (CPU) time and energy by the given thread. This means that the CPU of the mobile device is busy processing these steps. The thicker part is shown in only one line at a time, meaning that the CPU time consumption is not overlapping (the CPU of the mobile device is not working in parallel) for processing the different threads. It can be seen that CPU time is always only consumed in one thread at a time—the operating system thread or the application thread.

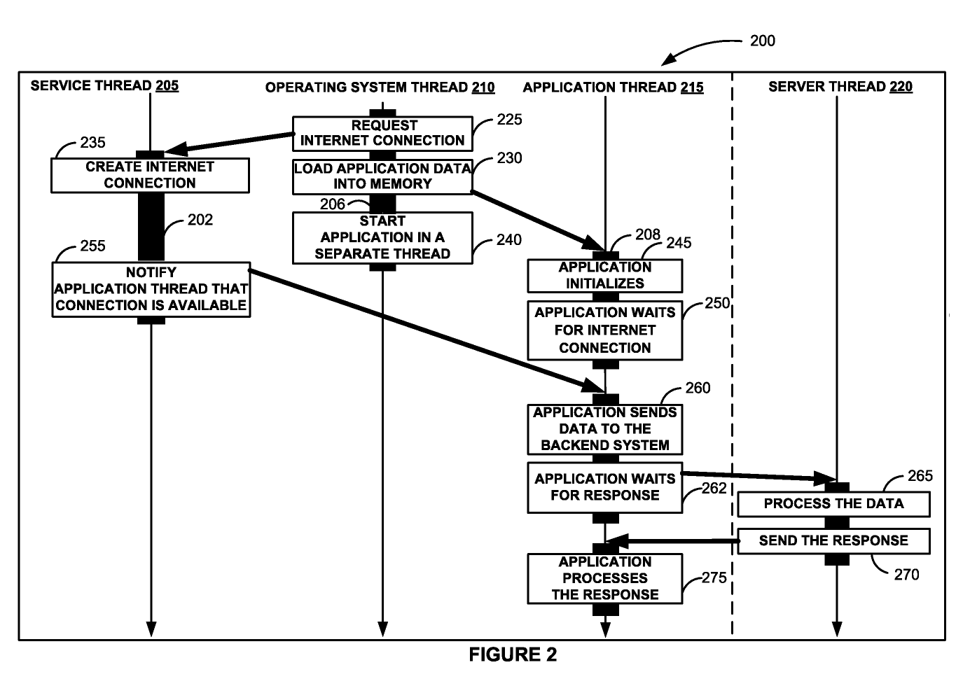

FIG. 2 is a block diagram illustrating a method for creating an Internet connection for a mobile application according to an embodiment. In various embodiments, an Internet connection is created for a mobile application hosted on a mobile device. If the operating system 105 of the mobile device triggers a service running in a separate thread from the operating system thread that immediately creates an Internet connection and notifies the mobile application 110 when the Internet connection is complete, then significant response time for the request first sent to the backend system can be saved.

Process 200 includes different steps performed in different threads. In various embodiments, the steps performed by the service that creates the Internet connection are performed in a service thread 205 (or a service process). The steps performed by the operating system of the mobile device are performed in an operating system thread (or process) 210, the steps performed by the mobile application are performed in an application thread (or process) 215, and the steps performed by the backend system are performed in a server thread (or process) 220. The bold arrows between the blocks in process 200 show which thread will become active. The connections between the blocks in the different threads end with thicker edges showing consumption of CPU time and energy by the given thread. This means that the CPU is busy processing these steps. In process 200, some thicker parts of the lines of the threads are overlapping, which means that the CPU is working and processing steps of the different threads in parallel. For example, at the time when there is a thicker part 202 of the service thread 205 between the two blocks, there are also thicker parts in the operating system thread 210 (e.g., part 206) and the application thread 215 (e.g., part 208). This means that at the same time, the CPU is executing steps of the different threads in parallel. Thus, reducing the overall wait time by reducing the wait time between executing some of the steps. For example, like reducing the time the mobile connection waits for a free slot at the relay tower. The time for creating the Internet connection is started earlier and ends earlier than in process 100. This leads to reduction of the time the user has to wait for receiving a response.

At block 225, the operating system requests an Internet connection by triggering a service running in the service thread 205 to create the Internet connection. The service thread 205 works in parallel with the operating system thread 210 and the application thread 215. At block 230, the operating system loads the mobile application data in the internal memory of the mobile device. At the same time the mobile application is loaded into the internal memory of the mobile device, the service starts creating the Internet connection in the service thread 205, at block 235. The service builds up a mobile connection, waits for a free slot for the mobile connection at the relay tower, and then a connection over the Internet to the backend is established (e.g., a TCP/IP connection). On top of establishing the mobile connection with the mobile carrier, the Internet connection (e.g., TCP/IP connection, an HTTP/HTTPS connection, etc.) is also being established by the service thread 205 in parallel to the execution of some of the steps of the operating system thread 210 and the application thread 215, where wait time is involved. Thus, overall reduction of the wait time is achieved.

While the service thread 205 creates the Internet connection, the operating system starts the mobile application in a separate thread, the application thread 215, at block 240. The application thread 215 becomes active. At block 245, the mobile application starts initialization of the internal memory for the application data. For example, the mobile application needs to build up user interfaces, perform initializations of some variables, computations, and so on. In an embodiment, the initialization is also performed in parallel to the Internet connection creation.

At block 250, the mobile application waits for a created Internet connection. Since, the creating of the Internet connection was delegated to the service in the service thread 205 at the beginning and being performed in parallel to the loading of the mobile application into the memory and the initialization of the application data, the Internet connection is available to the mobile application significantly earlier. Thus, the wait time for the Internet connection at block 250 is significantly short. At block 255, the service thread 205 notifies the application thread 215 that there is an available Internet connection, which the mobile application can use. At block 260, the mobile application sends data to the backend system over the created Internet connection. The mobile application then waits for a response from the backend system, at block 262. The server thread 220 becomes active. At block 265, the backend system processes the data received with the user request from the mobile application. At block 270, the backend system sends the response to the mobile application. At block 275, the mobile application processes the response, e.g., displays a result on the user interface of the mobile device.

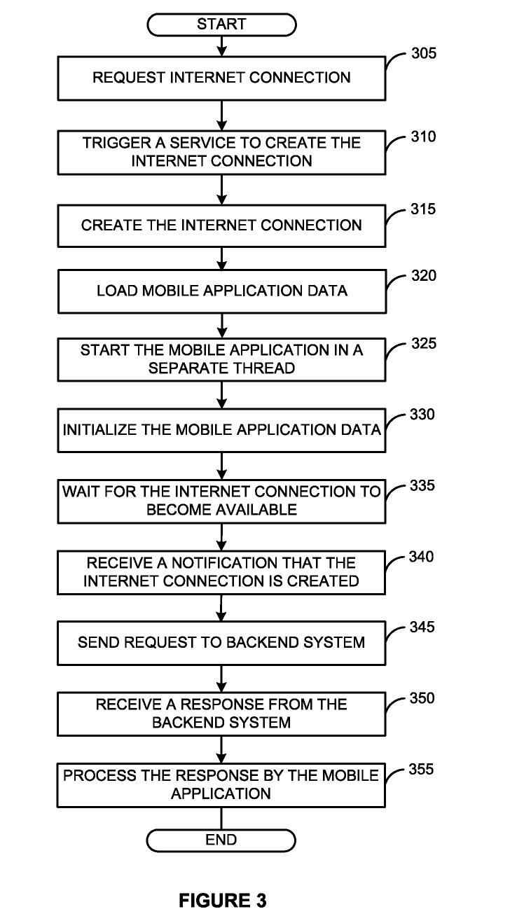

FIG. 3 is a flow diagram illustrating the method for creating an Internet connection in an operating system of a mobile device, according to an embodiment. In various embodiments, an Internet connection is created in parallel to loading the application data and starting the application. At block 305, an internet connection is requested from the operating system of a mobile device. The internet connection is not requested from the mobile application installed on the mobile device, but from the operating system. At block 310, a service is triggered from the operating system to create the Internet connection. The service is running in a service thread or process (such as service thread 205), the operating system of the mobile device is running in an operating system thread or process (e.g., operating system thread 210), the mobile application is running in an application thread or process (e.g., application thread 215), and the backend system processes the requests from the mobile device in a server thread or process (e.g., server thread 220).

At block 315, the Internet connection is created in the service thread. Creating the Internet connection includes creating a mobile connection to a relay tower in the area where the mobile device is located, waiting for a free slot at the relay tower for the mobile connection, establishing communication protocols (e.g., TCP/IP, HTTP/HTTPS), and so on, and then the connection over the Internet to the backend is established. At the same time, the mobile application data is loaded into the main memory of the mobile device by the operating system in parallel to the creating of the Internet connection, at block 320. At block 325, the mobile application is started in a separate thread, the application thread, from the operating system in parallel to the creation of the Internet connection as well. At this point, the application thread becomes active. At block 330, the mobile application initializes the mobile application data in the memory in the application thread. At block 335, the mobile application waits for the Internet connection to become available. Since creating the Internet connection has been started earlier in the process, as a first step, the Internet connection is created and becomes available for use significantly early. Thus, the mobile application does not need to wait a long time for the Internet connection, as in process 100.

In various embodiments, the Internet connection could already be available and no waiting would be necessary in that case. For example, if the mobile application is a complex application that includes a lot of user interfaces that draw images, graphics, or charts, or render videos (or some other functionality that takes a lot of time for loading) at starting of the application and before the user enters some data, then loading of the application and starting the application in the application thread will take longer time than establishing the Internet connection. Therefore, after the mobile application data is loaded in the memory and the mobile application is started, the Internet connection will already be created and available for use by the mobile application immediately after the user enters some data in the user interface that requires response.

In other embodiments, the mobile application itself may need to request the backend system to obtain some information needed for loading a given user interface, where no user input is required. For example, in a mobile application that shows the weather for different locations, at the start of the application, all data, images and charts are loaded in the memory and a request for creating an Internet connection is sent to the service thread in parallel. By the time mobile application data is loaded and the mobile application is started in a separate thread, the Internet connection is already created and available. Then, the mobile application sends a request to the backend system to obtain what the current weather is at a given location. In this way, by processing several steps in parallel in different threads, the overall wait time is shortened.

At block 340, a notification is received at the mobile application from the service thread that the Internet connection is created and available for use. At block 345, the mobile application sends a request to the backend system over the created Internet connection. The user request may include, but is not limited to, requesting data, sending data, or reading data from the backend system. The backend system processes the user request from the mobile application in the server thread. At block 350, a response is received at the mobile application from the backend system to the sent user request. At block 355, the mobile application processes the response in the application thread.

In various embodiments, the method described herein for creating an internet connection in parallel to the loading and starting of the application to reduce the wait time of the mobile application, and hence the user wait time for a response, can be implemented as an optional feature in the operating system of a mobile device. This optional feature can be turned on and off by the user, or set to active by default for all Internet connections made from the mobile device.

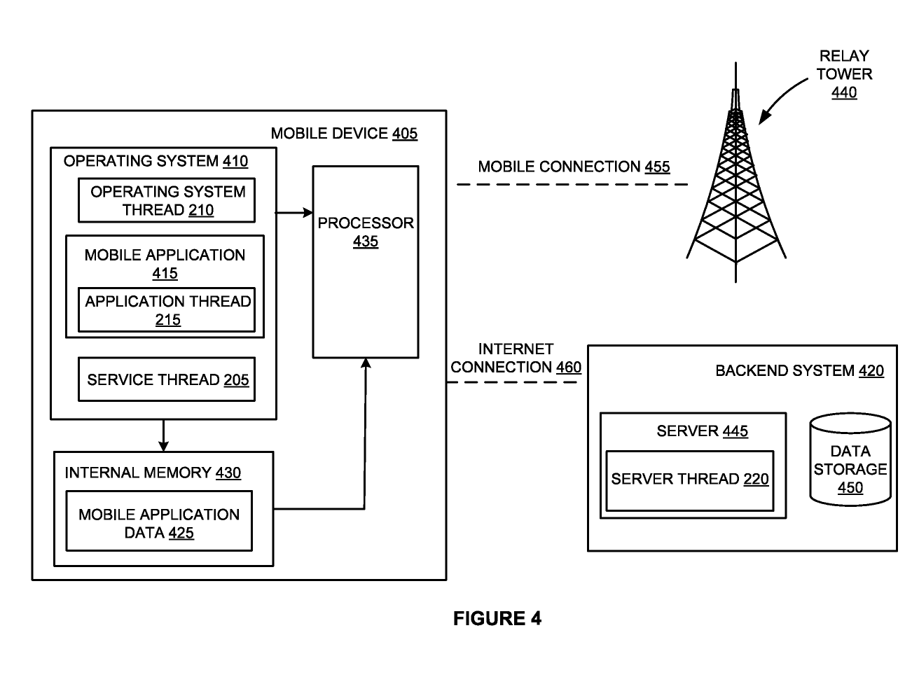

FIG. 4 is block diagram illustrating a method for creating a network connection between a mobile device and a backend system, according to an embodiment. Mobile device 405 is a typical handheld computing device that has a screen and/or a minimized keyboard. On mobile device 405, an operating system 410 is installed and running. The operating system 410 is a platform environment for mobile applications such as Palm OS®, BlackBerry®, Android®, Symbian®, and so on. The operating system 410 includes one or more mobile applications deployed and running, such as mobile application 415. The operating system 410 also includes an operating system thread (or process) 210 that performs tasks such as: requests network connections, loads mobile applications data 425 into internal memory 430, and so on. In various embodiments, operating system 410 also includes a service thread (or process) 205. The service thread 205 is responsible for creating an Internet connection 460 for mobile application 415 in parallel to the tasks performed by the operating system thread 210. Once the Internet connection is created and available for use, the service thread 205 notifies the mobile application 415. Mobile application 415 includes an application thread (or process) 215 that initializes the mobile application data into the internal memory of the mobile device 405, sends requests to backend system 420, processes the response received from the backend system 420, and so on.

In various embodiments, the operating system 410 of the mobile device 405 is in communication with processor 435. Processor 435 is a unit in the mobile device 405 that performs the instructions of the operating system thread 210, the service thread 205, the application thread 215, and so on. The mobile device 405 also includes internal memory 430. Internal memory 430 is the primary (main) memory of the mobile device 405 (e.g., the random-access memory (RAM)). Internal memory 430 includes temporary mobile application data 425 loaded from the permanent storage of the mobile device (e.g., hard disk drive) by the operating system thread 210 needed for starting and executing mobile application 415. Internal memory 430 is in communication with the operating system 410 and the processor 435.

The service thread 205 of the operating system 410 creates the Internet connection 460 by firstly creating a mobile connection 455 to relay tower 440. When the mobile connection 455 to the relay tower 440 is established, then the Internet connection 460 to the backend system 420 is created. After the Internet connection 460 is created, the service thread 205 notifies the application thread 215 for the available Internet connection 460. The application thread 215 sends a request to the backend system 420. The backend system 420 includes a server 445 such as an application server and a data storage unit 450. Server 445 includes a server thread (or process) 220 that processes the request sent from the mobile device 405. Data storage unit 450 includes business data needed for the mobile application 415.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

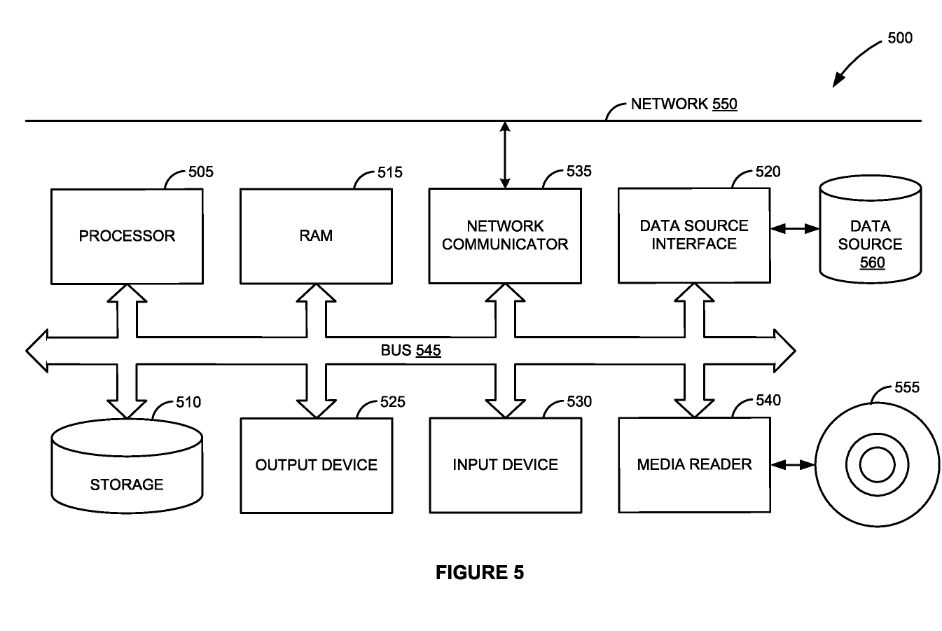

FIG. 5 is a block diagram illustrating an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output 525 and input 530 devices could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be access via one or more abstraction layers implemented in hardware or software. For example, the data source 560 may be access by network 550. In some embodiments the data source 560 may be accessed via an abstraction layer, such as, a semantic layer.

A data source 560 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
request an Internet connection from an operating system of a mobile device for a mobile application;
create the Internet connection in a service thread, wherein the service thread is separate from a operating system thread that executes tasks of the operating system;
load mobile application data into internal memory of the mobile device in parallel to creating the Internet connection; and
start the mobile application in an application thread in parallel to creating the Internet connection.

2. The article of manufacture of claim 1, wherein to request the Internet connection comprises triggering a service to create the Internet connection in the service thread.

3. The article of manufacture of claim 1, further comprising instructions to cause the computer to:
initialize the mobile application data from the internal memory in the application thread in parallel to creating the Internet connection;
wait for the Internet connection to be created and available for use by the mobile application; and
receive a notification that the Internet connection is created immediately after or during loading the mobile application data and starting the mobile application.

4. The article of manufacture of claim 1, further comprising instructions to cause the computer to:
send a request from the mobile application to a backend system over the created Internet connection; and
receive a response from the backend system to the sent request.

5. The article of manufacture of claim 4, further comprising instructions to cause the computer to:
process the response from the backend system in the application thread; and
display a result in response to processing the response from the backend system.

6. The article of manufacture of claim 1, wherein to create the Internet connection comprises:
building up a mobile connection to a relay tower close to the mobile device; and
waiting for an available free slot to be open at the relay tower.

7. The article of manufacture of claim 6, further comprising instructions to cause the computer to: establish the Internet connection over the mobile connection via network communication protocols.

8. A computerized method comprising:
requesting an Internet connection from an operating system of a mobile device for a mobile application;
creating the Internet connection in a service thread, wherein the service thread is separate from a operating system thread that executes tasks of the operating system;
loading mobile application data into internal memory of the mobile device in parallel to creating the Internet connection; and
starting the mobile application in an application thread in parallel to creating the Internet connection.

9. The method of claim 8, wherein requesting the Internet connection comprises triggering a service to create the Internet connection in the service thread.

10. The method of claim 8, further comprising:
initializing the mobile application data from the internal memory in the application thread in parallel to creating the Internet connection;
waiting for the Internet connection to be created and available for use by the mobile application; and
receiving a notification that the Internet connection is created immediately after or during loading the mobile application data and starting the mobile application.

11. The method of claim 8, further comprising:
sending a request from the mobile application to a backend system over the created Internet connection; and
receiving a response from the backend system to the sent request.

12. The method of claim 11, further comprising:
processing the response from the backend system in the application thread; and
displaying a result in response to processing the response from the backend system.

13. The method of claim 8, wherein creating the Internet connection comprises:
building up a mobile connection to a relay tower close to the mobile device; and
waiting for an available free slot to be open at the relay tower.

14. The method of claim 13, further comprising establishing the Internet connection over the mobile connection via network communication protocols.

15. A system comprising:
a processor;
a memory in communication with the processor, the memory comprising:
an operating system thread that requests an Internet connection for a mobile application, loads mobile application data in internal memory of a mobile device, and starts the mobile application in a thread separate from the operating system thread;
a service thread that creates the Internet connection in parallel to loading the mobile application data and starting the mobile application by the operating system thread and sends a notification that the Internet connection is created immediately after or during loading of the mobile application data and starting of the mobile application; and
an application thread that receives the notification that the Internet connection is created and available.

16. The system of claim 15, wherein the application thread initializes the mobile application data from the internal memory and waits for the Internet connection to be created and available for use by the mobile application.

17. The system of claim 16, wherein the application thread sends a request from the mobile application to a backend system over the created Internet connection.

18. The system of claim 15, wherein the service thread builds up a mobile connection to a relay tower close to the mobile device and waiting for an available free slot to be open at the relay tower.

19. The system of claim 17, further comprising a server thread that processes the request sent from the mobile application at the backend system.

20. A system including a mobile device, a relay tower, and a backend server, the system comprising:
a mobile device including: an operating system thread that requests an Internet connection for a mobile application, a service thread the creates the Internet connection in parallel to loading the mobile application into a memory and initializing mobile application data from the memory, and an application thread that sends a request from the mobile application;
a relay tower that opens a free slot for establishing a mobile connection with the mobile device; and
a backend server that includes a server thread to process the request sent from the mobile application over the created Internet connection and the established mobile connection.
